(19) United States
(12) Patent Application Publication
(10) Pub. No.: US 2018/0308344 A1
(43) Pub. Date: Oct. 25, 2018

(54) VEHICLE-TO-INFRASTRUCTURE (V2I) ACCIDENT MANAGEMENT

(71) Applicant: Cisco Technology, Inc., San Jose, CA (US)

(72) Inventors: Ram Mohan Ravindranath, Bangalore (IN); K. Tirumaleswar Reddy, Bangalore (IN); Carlos M. Pignataro, Raleigh, NC (US); Prashanth Patil, San Jose, CA (US)

(21) Appl. No.: 15/492,559

(22) Filed: Apr. 20, 2017

(51) Int. Cl. G08B 27/00; B60R 21/00; G06F 19/00

(52) U.S. Cl. CPC G08B 27/001; B60R 2021/0027; G06F 19/322; B60R 21/00

(57) ABSTRACT

In one embodiment, a computing device determines that a vehicle has been in an accident. The computing device also receives virtual black box data having a finite time period of recorded data from sensors that were in an operating mode during the finite time period prior to the accident, as well as a stream of data from sensors that changed to an accident mode in response to the accident. The computing device may then coordinate the virtual black box data and the stream of data for distribution to accident-based services. In another embodiment, a computing device determines identities of vehicle occupants. In response to an accident at a location, the device further determines one or more emergency services responsive to the accident at the location. As such, the device may then provide access to medical records of the occupants to devices associated with the determined emergency services.

### TECHNICAL FIELD

The present disclosure relates generally to computer networks, and, more particularly, to vehicle-to-infrastructure (V2I) accident management.

### BACKGROUND

In general, vehicular accidents are usually reported manually, such as a victim (e.g., occupant) reporting the accident over the phone, or else some other third-party observer who witnessed or passed by an accident after its occurrence. More recently, the vehicles themselves have been able to report accidents, in response to one or more sensors on the vehicle that can detect and report the accident to a connected-vehicle infrastructure (e.g., cellular or road-side wireless communication devices). Typically, however, the current state of the art merely indicates that an accident has occurred, along with limited details such as, for example, the location of the incident, vehicle details, severity of the accident, and if observable, severity of the injuries.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example vehicle-to-infrastructure (V2I) computer network;

FIG. 2 illustrates an example computing device;

FIG. 3 illustrates an example V2I initialization for accident management;

FIG. 4 illustrates an example of V2I accident management;

FIG. 5 illustrates an example procedure for V2I accident management; and

FIG. 6 illustrates another example procedure for V2I accident management.

### DESCRIPTION OF EXAMPLE EMBODIMENTS

### Overview

According to one or more embodiments of the disclosure, a computing device determines that a vehicle has been in an accident. The computing device also receives virtual black box data having a finite time period of recorded data from one or more sensors that were in an operating mode during the finite time period prior to the accident, as well as a stream of data from at least one of the one or more sensors that changed to an accident mode in response to the accident. The computing device may then coordinate the virtual black box data and the stream of data for distribution to one or more accident-based services.

According to one or more additional embodiments of the disclosure, a computing device may determine identities of one or more occupants of a vehicle. The device may then determine that the vehicle has been in an accident at a location, and further determines one or more emergency services responsive to the accident at the location. As such, the device may then provide access to medical records of the one or more occupants to one or more devices associated with the determined emergency services.

### Description

A computer network is a geographically distributed collection of nodes interconnected by communication links for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links.

One specific type of network is a vehicle-to-infrastructure (V2I) computer network, allowing communication linking from vehicles (e.g., cars) to other cars and to other computers (e.g., sensors) within their surroundings, and further connecting such devices with a larger network, such as one or more servers of a proprietary traffic control WAN, or even the Internet in general.

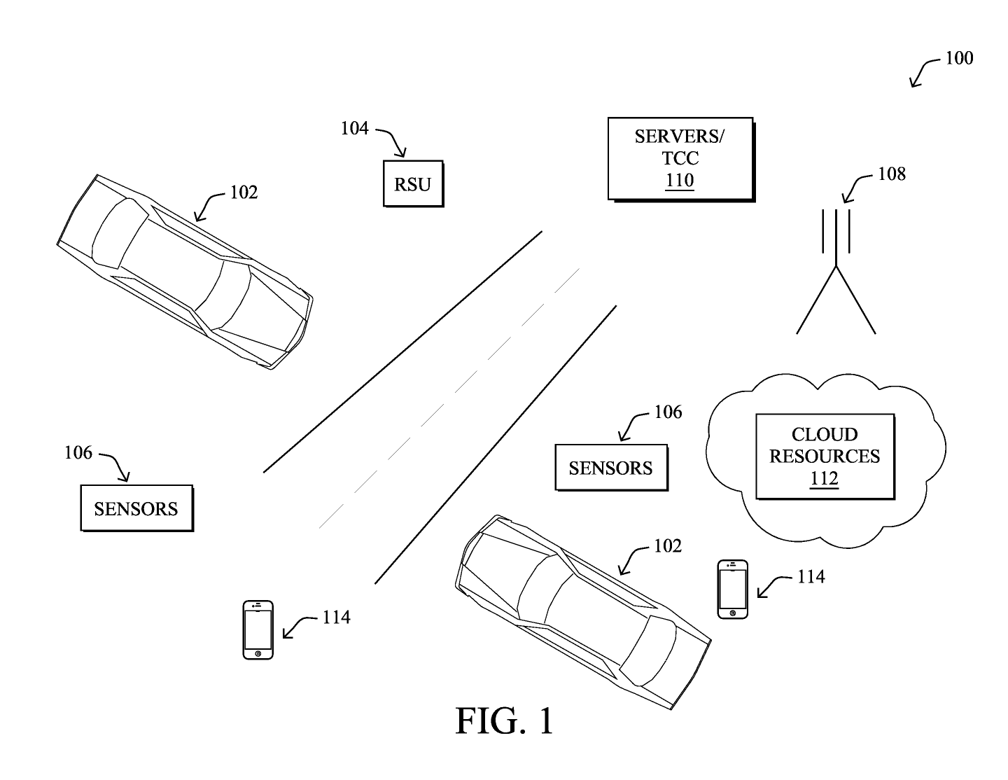

FIG. 1 illustrates an example simplified V2I computer network 100, which may be used as a reference while describing one or more embodiments of the present disclosure. As shown, V2I network 100 may comprise one or more vehicles 102 one or more road-side units (RSUs) 104, one or more sensors 106 (e.g., traffic sensors, speed sensors, video sensors/cameras, audio sensors/microphones, etc.), one or more cellular towers 108, and one or more servers 110 (e.g., traffic control center or “TCC” servers). Other devices, such as cloud computing resources 112, smartphones 114 (e.g., from users in the vicinity, occupants of vehicles), and other sensors or devices as desired.

In general, vehicles 102 may comprise one or more sensors, such as various vehicular sensors (e.g., speed sensors, acceleration sensors, braking sensors, engine operation sensors, etc.), observational sensors (e.g., video sensors, audio sensors, location sensors, etc.), and so on. Other sensors, such as sensors 106, sensors on RSUs 104, and the user devices/smartphones 114, may also comprise various observational sensors. As described herein, sensors may range from sensing-only (e.g., and communicating through a gateway or other controlling device), to being intelligently self-controlled (autonomous processing and communication parameters).

Also, as described below, servers 110 may also correspond to one or more accident-based services, such as a hospital computing system, an ambulance computing system, a police computing system, a fire department computing system, an insurance computing system, an automotive manufacturer computing system, a self-driving controller learning machine system, an accident reconstruction computing system, and any other vehicular or accident-related systems as may be appreciated by those skilled in the art. Also, such systems may comprise additional devices, such as display devices, communication devices, notification devices, and so on.

The computer network 100 may include any number of wired or wireless links between devices, such as Ethernet-based links, fiber-optics-based links, coaxial-based links, near-field-based links, WiFi® links, satellite links, cellular links, infrared links, combinations thereof, or the like. Data packets traverse the links between the devices and carry information, instructions, messages, and so on, as will be appreciated by those skilled in the art.

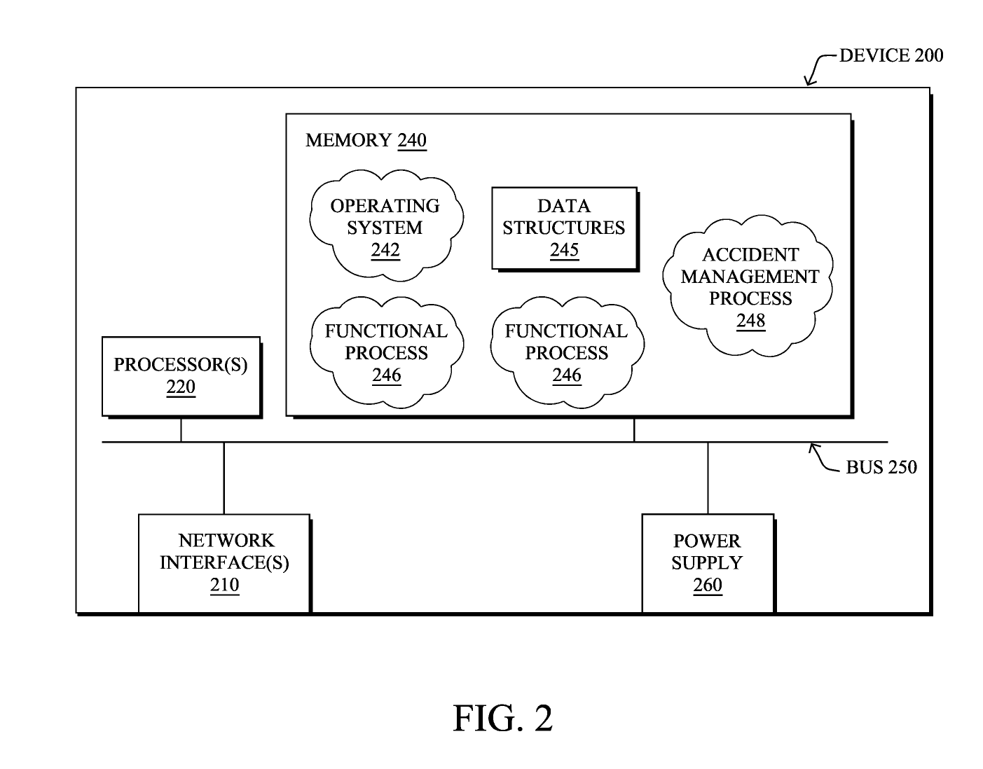

Referring now to FIG. 2, an example electronic device 200 is shown that may be used with one or more embodiments described herein, e.g., as any of the devices described with respect to FIG. 1 above (e.g., vehicles 102, sensors/devices within vehicles 102, RSUs 104, sensors 106, servers 110, cloud resources 112, smartphones 114, etc.). Generally, device 200 may comprise one or more network interfaces 210 (e.g., wired, wireless, etc.), at least one processor 220, and a memory 240 interconnected by a system bus 250, as well as a power supply 260 (e.g., battery, etc.).

The network interface(s) 210 include the mechanical, electrical, and signaling circuitry for providing a data connection between device 200 and a data network, such as the Internet. For example, interfaces 210 may include wired transceivers, cellular transceivers, WiFi transceivers, or the like, to allow device 200 to request and/or receive information from a remote computing device or server.

The memory 240 comprises a plurality of storage locations that are addressable by the processor 220 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by processor 220, functionally organizes device 200 by, among other things, invoking operations in support of software processes and/or services executing on the device. These software processes and/or services may comprise one or more functional processes 246, and on certain devices, an illustrative V2I accident management process 248, as described herein. Notably, functional processes 246, when executed by processor(s) 220, cause each particular device 200 to perform the various functions corresponding to the particular device's purpose and general configuration. For example, a sensor would be configured to operate as a sensor, an RSU would be configured to operate as an RSU, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

—V2I Accident Management—

As noted above, vehicular accidents are usually reported manually or by more advanced and connected vehicles themselves. As also noted above, however, current accident reporting merely indicates that an accident has occurred, along with limited details such as, for example, the location of the incident, vehicle details, severity of the accident, and if observable, severity of the injuries. In many cases, this information may not be sufficient for target parties (such as, e.g., a hospital, a tow service, a vehicle repair service center, insurance companies, and so on) to plan for or take an appropriate course of action. For instance, it would be helpful for a hospital to get the medical history of the driver and passengers in the vehicle to prepare for required medical treatment before an emergency vehicle reaches the accident site. The vehicle repair station might also prefer to get more details about the level of damage to the vehicle to assess the type of equipment and repair specialists required even before reaching the accident site.

In addition to typical location and vehicle details, there can be an immense amount of contextual information, such as information gathered from sensors close to the accident site, as well and multi-modal information gathered from the vehicle itself (e.g., video, audio, accelerometer output, etc.), that is potentially useful for accident analysis.

The techniques described herein, therefore, comprehensively report accident events, particularly leveraging the Intelligent Transport System (ITS) and/or IP Wireless Access in Vehicular Environments (IPWAVE). In particular, the techniques herein may be configured to transmit the health care records of the victims involved in the accident (e.g., using WebRTC technology) along with automated archiving of on-vehicle sensor readings and streaming access to various insightful sensors (e.g., video, audio, etc.).

Specifically, according to one or more embodiments of the disclosure as described in detail below, a computing device (e.g., traffic control center) determines that a vehicle has been in an accident. The computing device also receives virtual black box data having a finite time period of recorded data from one or more sensors that were in an operating mode during the finite time period prior to the accident (e.g., from the vehicle and/or road-side units in the vicinity), as well as a stream of data from at least one of the one or more sensors that changed to an accident mode in response to the accident. The computing device may then coordinate the virtual black box data and the stream of data for distribution to one or more accident-based services. According to one or more additional embodiments of the disclosure as described in detail below, a computing device may determine identities of one or more occupants of a vehicle. The device may then determine that the vehicle has been in an accident at a location, and further determines one or more emergency services responsive to the accident at the location. As such, the device may then provide access to medical records of the one or more occupants to one or more devices associated with the determined emergency services.

Illustratively, the techniques described herein may be performed by hardware, software, and/or firmware, such as in accordance with the illustrative “accident management” process 248, which may include computer executable instructions executed by a processor 220 on one or more sufficiently configured devices within the V2I environment (e.g., vehicle, road-side units, servers, etc.) to perform functions relating to the techniques described herein. In one or more embodiments, the functional processes 246 of various devices may also operate in conjunction with accident management process 248, whether on the same device or conjunction across different devices.

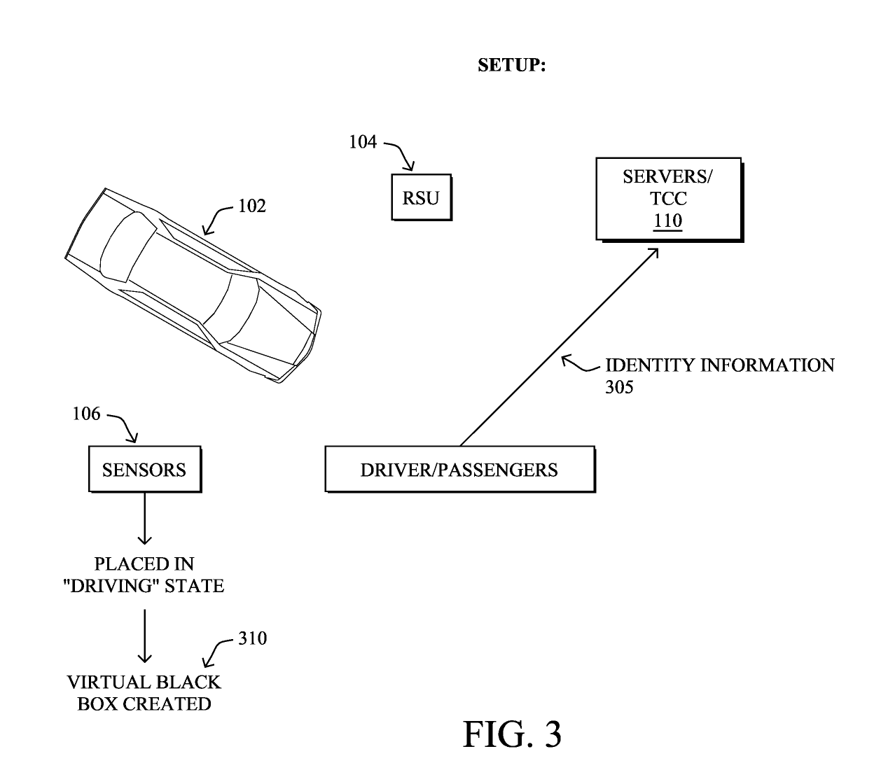

Operationally, and with reference to FIG. 3 (showing a simplified portion of network 100), according to one or more embodiments herein, when a driver boards a vehicle, the driver and optionally other passengers (collectively, “occupants”) may be identified and/or authenticated within the vehicle. For example, the driver may provide his/her identity and the identity of the passengers, such as through a manual log-in, or else the identity of the occupants may be completed automatically, such as based on a wearable/mobile devices of the occupants, or based on biometrics (e.g., facial recognition, etc.). The information 305 about the occupants may then be conveyed to Traffic Control Center (TCC) or other relevant servers, for use as described below.

While driving (or otherwise operating), the vehicle (e.g., car) one or more vehicular sensors may be placed in an “operating mode” (or “driving mode”), where the previous “X” seconds are cached, thus establishing a finite time period of recorded data. For example, certain sensors, such as GPS sensors, accelerometers, various cameras, etc., may be placed in a mode where the last fifteen seconds (or so) are recorded.

A “virtual black-box” 310 may also be created by the logical compilation of the short recorded history of the sensors (in particular cameras), leading up to an accident. That is, virtual black box data, from the involved vehicle and/or other vehicles or RSUs, may contain a finite time period of recorded data from one or more sensors in operating mode prior to an accident.

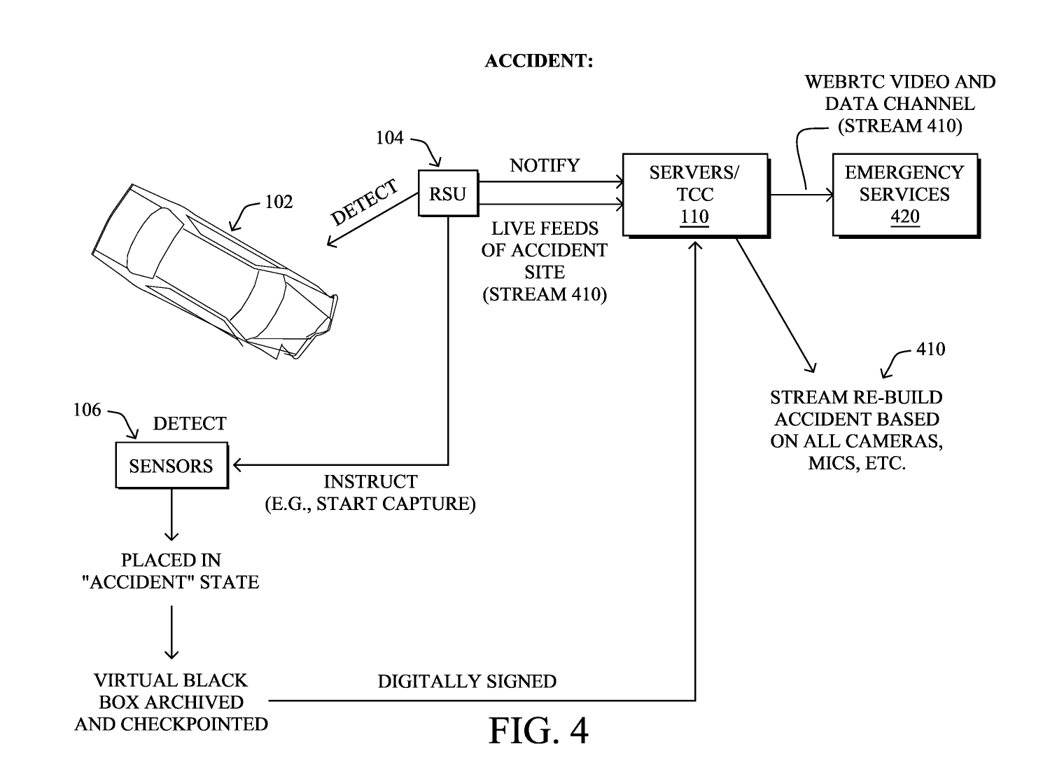

With reference now to FIG. 4, where an accident has now occurred, accidents or other emergency situations can be detected by sensors in the vehicle, sensors in peer vehicles, road sensors, etc., and reported to a Road-Side Unit (RSU), or further reported to one or more corresponding servers (e.g., TCC servers). Manual reporting is also possible (e.g., calls from cellphones or otherwise).

In one particular embodiment herein, the RSU 104 in proximity to the vehicle 102 at the time of the accident may validate (confirm) the reported information and notifies the Traffic Control Center (TCC) server that the accident occurred at the location. The server 110 may then look up the vehicle details and identity of the vehicle's occupants (e.g., driver and/or passengers in the vehicle).

Additionally, in one embodiment herein, an RSU may also notify the TCC/server of the identity of one or more emergency vehicles (ambulance, helicopter, etc.) reaching the crash site. Using this information, or other correlation to responsive emergency services 420 (e.g., strictly based on the location or region of the accident, or other mechanisms to determine the responsive services), the TCC may provide the emergency services 420 with the medical records of one or more of the occupants. For instance, the TCC may notify a hospital network to authorize the emergency vehicle and its associated hospitals (e.g., using an authentication protocol, as will be understood by those skilled in the art) to grant access to the driver's and passengers' medical records.

According to one or more further embodiments of the present disclosure, the TCC in turn may receive live feeds of the accident site and vehicle(s) via the vehicle(s) in the accident, vehicles near the accident, or the local RSU, such as by requesting camera sensors on the road to capture or obtain video of the accident (or thereafter). This accident-based data may be passed to the TCC, which in turn can make a real-time communication connection (e.g., a WebRTC call) to hospital emergency units and convey the information using a corresponding video stream. Note that the TCC may also make a connection to the involved vehicle's authorized service center, the driver's insurance company, and other associated services. Other emergency services, such as tow companies, may also receive vehicle location information and photos or video of vehicle condition through a live stream (e.g., a WebRTC data channel).

The techniques herein also provide “contextual sensing” in one or more particular embodiments. For instance, in response to an accident condition, sensors, which were previously in operating mode, may be placed into an “accident mode”, where live data may be streamed (streams 410), such as cameras, microphones, etc. As such, the TCC server 110 may be configured to receive, from one or both of the vehicle 102 and RSU 104, a stream of data from at least one of the one or more sensors that changed to an accident mode in response to the accident. It is important to understand that current vehicles have a plurality of cameras and microphones. These include surround view, rear view, front view, side view, inside view, etc. Having these cameras placed into accident mode for live streaming, as well as sending the prior recordings from these camera in the virtual black box can be the difference in saving a life (or lesser so, for insurance claims, repair service, vehicle improvements, road infrastructure design improvements, self-driving car driving patterns, etc.).

Sensors (or a gateway on the vehicle/RSU configured to receive sensor data) may thus record the last few seconds in operating/driving mode, illustratively for all of the sensors at its disposal, and when in accident mode, the data may be compiled and archived for all the different audio and/or video captures from the sensors (including from cameras, microphones, etc.), packaging it as streaming data (e.g., streaming virtual black box data), such as by make it part of an Intelligent Transportation System (ITS) message flow. In this manner, the TCC server 110 may be configured to coordinate the virtual black box data and the stream of data for distribution to one or more accident-based services (e.g., emergency services, responding services, investigative services, etc.), and may also provide access to medical records of the one or more occupants to one or more emergency service devices, as mentioned above.

Note that as also mentioned above, there are a variety of current technologies that can be used to detect and report accidents, including vehicle details. However, the techniques herein relay additional information, such as the impact of the accident, live video, photos of the vehicle, occupant details, etc. Specifically, the techniques herein rely on the infrastructure network (e.g., the TCC, RSU, road sensors, etc.), and not merely on vehicle sensors only. In this manner, even if the vehicle is completely damaged (which can damage sensors and their units as well), reporting from a vehicle may become difficult or inconsistent. In addition, the techniques herein may also correlate accident detection based on road sensors, neighboring vehicle sensors, and so on, and may report the accidents from the neighboring vehicles, other cameras that are part of road infrastructure, or other devices in proximity in order to capture and provide more details about an accident to the TCC. Moreover, the techniques herein need not be limited to proprietary relationships between a vehicle (manufacture/car owner) and a provider of accident detection services, which not only opens the techniques beyond proprietary systems, but allows for non-owners to drive the car.

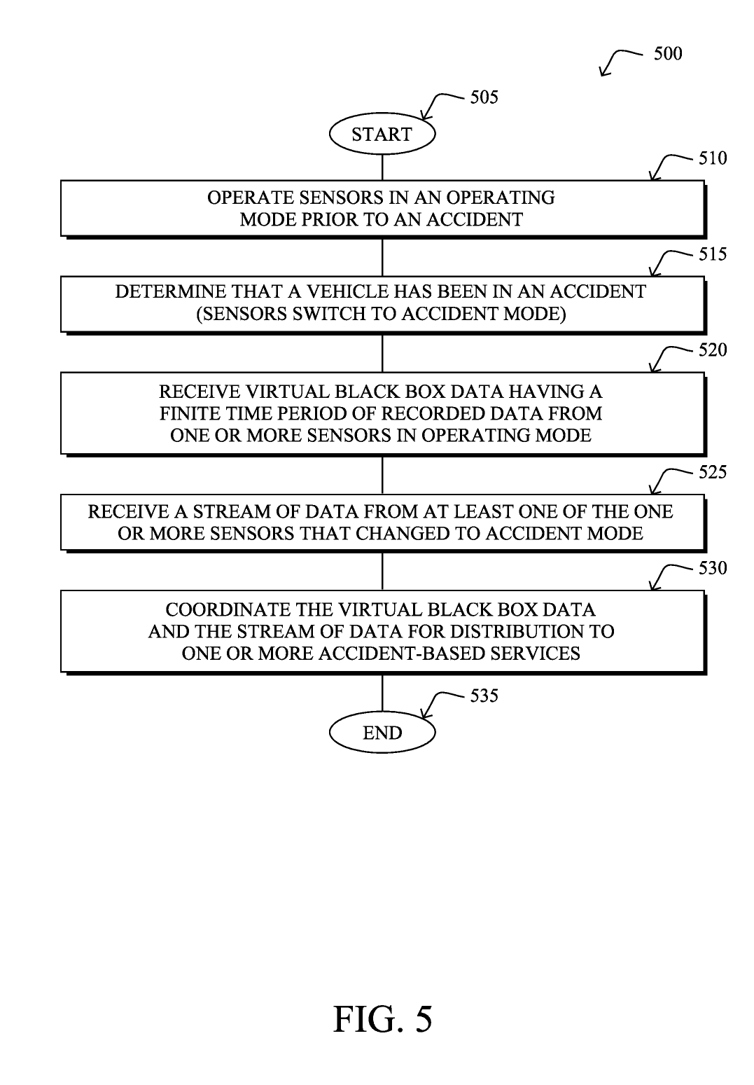

FIG. 5 illustrates an example procedure for V2I accident management in accordance with one or more embodiments described herein. For example, one or more non-generic, specifically configured computing devices (e.g., TCC server) may perform procedure 500 by executing stored instructions. As shown in FIG. 5, the procedure 500 may start at step 505, and continues to step 510, where, as described in greater detail above, one or more sensors operate in an operating mode prior to an accident, such as vehicle sensors, RSU sensors, or other sensors as noted above, such as, e.g., video sensors, audio sensors, speed sensors, acceleration sensors, braking sensors, engine operation sensors, and location sensors.

Once it is determined in step 515 that a vehicle has been in an accident (e.g., receiving a notification of the accident from one or both of the vehicle and an RSU in proximity of the vehicle), where one or more particular sensors switch to an accident mode (the switch being controlled on the sensors or by one or more network connectivity devices that manage communication of the sensors, e.g., a gateway), then in step 520 virtual black box data may be received by a computing device (e.g., TCC server) as mentioned above. For instance, the virtual black box data illustratively has a finite time period of recorded data from the sensors that were in an operating mode during the finite time period prior to the accident. In addition, in step 525 the techniques herein provide a stream of data from one or more sensors now in accident mode (e.g., that changed to accident mode) to the computing device (e.g., TCC server), such as video sensors (cameras), audio sensors (microphones), etc.

As such, in step 530, the techniques herein allow for coordinating the virtual black box data and the stream of data for distribution to one or more accident-based services (e.g., first responders, hospitals, rescue vehicles/departments, insurance companies, and so on). For example, video sensors at the location may be provided to display devices associated with certain emergency services, in order to allow the emergency workers to be informed of the situation before arriving on scene.

The illustrative procedure 500 may then end in step 535, notably continuing to coordinate (distribute, store, process, etc.) the virtual black box data and/or streaming data, accordingly. Note that in one embodiment, the virtual black box data may comprise identities of one or more occupants of the vehicle, such that the techniques herein may also be configured to provide access to medical records of the occupants to one or more emergency service devices. Alternatively, the identities of the occupants may be pre-loaded to the servers based on an initialization stage, as described above.

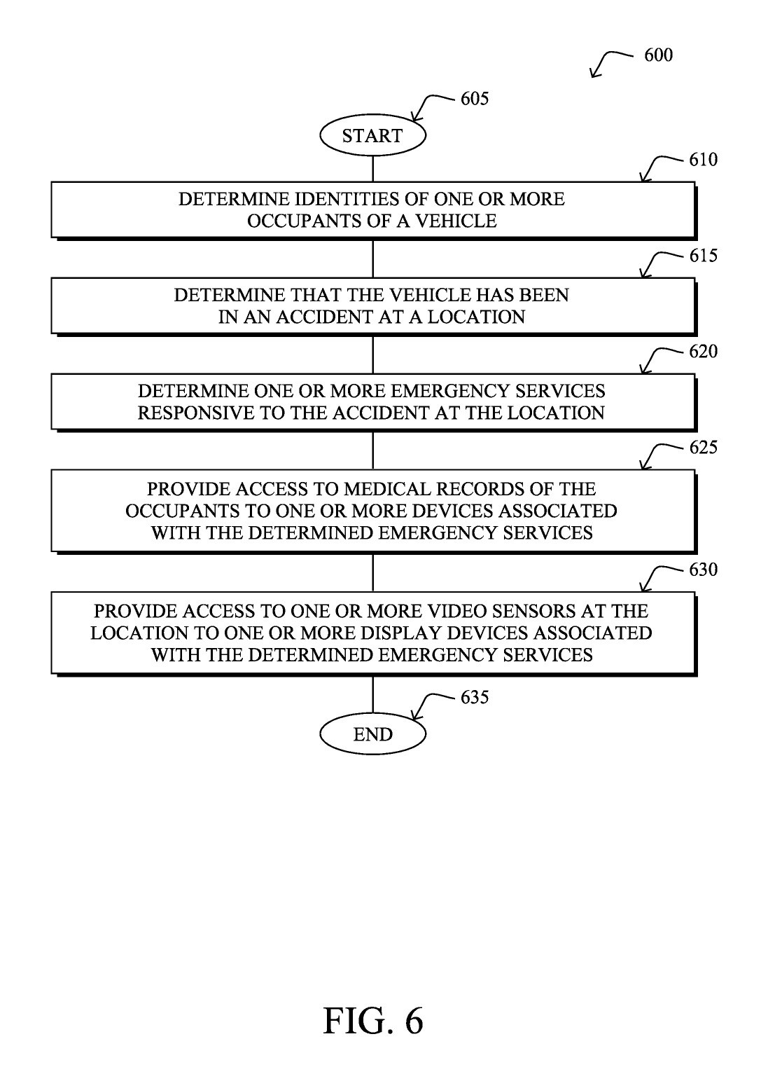

For instance, FIG. 6 illustrates another example procedure for V2I accident management in accordance with one or more embodiments described herein. For example, procedure 600 may start at step 605, and continues to step 610, where, as described in greater detail above, a computing device determines the identities of one or more occupants of a vehicle (e.g., the vehicle itself, a TCC server, etc.) based on one or more available techniques mentioned above (e.g., logging in, biometrics, and so on). Once it is determined in step 615 that the vehicle has been in an accident (e.g., at a particular location), then in step 620 a computing device (e.g., again the vehicle or more likely, the TCC server) may determine one or more emergency services responsive to the accident at the location, such as a hospital computing system, an ambulance computing system, a police computing system, a fire department computing system, and so on. Illustratively, the determination in step 620 may be based on correlating the location to a particular emergency service servicing the location, identifying an ambulance that has arrived at the location of the accident (e.g., based on video surveillance, radio signal interception, a response-notification application, etc.), and so on.

According to the techniques herein, in step 625 the computing device may then provide access to medical records of the one or more occupants to one or more devices associated with the determined emergency services. For instance, as mentioned above, the medical records may be sent from the computing device (e.g., a local repository or access to a database of medical records), or else permission may be provided for the emergency services to access the medical records from a database (e.g., tokens, keys, etc.), ensuring privacy is maintained, accordingly.

Also, in accordance with one or more embodiments herein, in step 630, the computing device (e.g., TCC server) may also provide access to one or more video sensors at the location to one or more display devices associated with the determined emergency services, as mentioned above.

The procedure 600 may then end in step 635.

It should be noted that while certain steps within procedures 500 and 600 may be optional as described above, the steps shown in FIGS. 5-6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 500 and 600 are described separately, certain steps from each procedure may be incorporated into each other procedure, and the procedures are not meant to be mutually exclusive. For instance, as noted above, a single system may be configured to perform V2I accident management where both medical records are managed, and virtual black box data is shared.

The techniques described herein, therefore, provide for advanced V2I accident management. In particular, the techniques herein capture and share valuable contextual information in response to accident detection, leveraging the ITS/IPWAVE architecture. Notably, the techniques do not require hardware changes to the vehicle, and scales beyond existing proposals.

It is worth noting again that accident management, in general, is a well-studied concept. However, no known techniques are part of the Intelligent Transportation System (ITS) leveraging the vehicle, the Road Side Units (RSUs), the Traffic Control Center (TCC) in a specific message flow as described above, particularly including the capturing and sending of adjunct context sensed. That is, by providing for different sensor states (e.g., “driving” or “accident” states), which may either be kept in the sensor itself or in the gateway of the vehicle, the functionality of a Virtual Black Box is established in a manner not previously conceived. For example, though black boxes are known, and telemetry data at the time of the crash can be retrieved (e.g., velocity and acceleration), the techniques herein advance this rudimentary technology by providing a fully automated capture of contextual information and reporting. Furthermore, the techniques herein leverage specific streaming from the RSU (assuming the car might not have connectivity), whereas previous techniques merely connect the car (and not the infrastructure) to an emergency response provider directly.

While there have been shown and described illustrative embodiments that provide for advanced V2I accident management, it is to be understood that various other adaptations and modifications may be made within the scope of the embodiments herein. For example, the embodiments may, in fact, be used in a variety of types of communication networks and/or protocols, and need not be limited to those illustrated above. For example, though the disclosure above mentions ITS, WebRTC, and other protocols, these are merely examples of V2I-related protocols based on current systems, and other suitable protocols or technologies may be used in accordance with the embodiments described above. Furthermore, while the embodiments may have been demonstrated with respect to certain vehicular environments (e.g., cars, trucks, or other road vehicles), other configurations may be conceived by those skilled in the art that would remain within the contemplated subject matter of the description above, such as airplanes, sea-craft/boats, and so on.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
determining, by a computing device, that a vehicle has been in an accident;
receiving, by the computing device, virtual black box data having a finite time period of recorded data from one or more sensors that were in an operating mode during the finite time period prior to the accident;
receiving, by the computing device, a stream of data from at least one of the one or more sensors that changed to an accident mode in response to the accident; and
coordinating, by the computing device, the virtual black box data and the stream of data for distribution to one or more accident-based services.

2. The method as in claim 1, wherein the one or more accident-based services are selected from a group consisting of: a hospital computing system; an ambulance computing system; a police computing system; a fire department computing system; an insurance computing system; an automotive manufacturer computing system; a self-driving controller learning machine system; and an accident reconstruction computing system.

3. The method as in claim 1, wherein sensors are selected from a group consisting of: vehicular sensors of the vehicle; vehicular sensors of a different vehicle in proximity to the accident; and observational sensors of a road-side unit in proximity to the accident.

4. The method as in claim 1, wherein the operating mode and accident mode are controlled on the sensors.

5. The method as in claim 1, wherein the operating mode and accident mode are controlled by one or more network connectivity devices that manage communication of the sensors.

6. The method as in claim 1, wherein the at least of the one or more sensors that changed to the accident mode are selected from a group consisting of: video sensors; and audio sensors.

7. The method as in claim 1, wherein the virtual black box data comprises data from one or more sensors selected from a group consisting of: video sensors; audio sensors; speed sensors; acceleration sensors; braking sensors; engine operation sensors; and location sensors.

8. The method as in claim 1, wherein determining that the vehicle has been in the accident comprises:
receiving a notification of the accident from one or both of the vehicle and a road-side unit in proximity of the vehicle.

9. The method as in claim 1, wherein the virtual black box data comprises identities of one or more occupants of the vehicle, the method further comprising:
providing access to medical records of the one or more occupants to one or more emergency service devices.

10. A method, comprising:
determining, by a computing device, identities of one or more occupants of a vehicle;
determining, by the computing device, that the vehicle has been in an accident at a location;
determining, by the computing device, one or more emergency services responsive to the accident at the location; and
providing, by the computing device, access to medical records of the one or more occupants to one or more devices associated with the determined emergency services.

11. The method as in claim 10, further comprising:
providing access to one or more video sensors at the location to one or more display devices associated with the determined emergency services.

12. The method as in claim 10, wherein determining that the vehicle has been in the accident comprises:
receiving a notification of the accident from one or both of the vehicle and a road-side unit at the location.

13. The method as in claim 10, wherein determining the one or more emergency services comprises:
correlating the location to a particular emergency service servicing the location.

14. The method as in claim 10, wherein determining the one or more emergency services comprises:
identifying an ambulance that has arrived at the location of the accident.

15. The method as in claim 10, wherein the determined emergency services are selected from a group consisting of: a hospital computing system; an ambulance computing system; a police computing system; and a fire department computing system.

16. The method as in claim 10, wherein providing access to medical records comprises:
sending the medical records from the computing device.

17. The method as in claim 10, wherein providing access to medical records comprises:
providing permission to access the medical records from a database.

18. The method as in claim 10, further comprising:
receiving, by the computing device, virtual black box data having a finite time period of recorded data from one or more sensors that were in an operating mode during the finite time period prior to the accident;
receiving, by the computing device, a stream of data from at least one of the one or more sensors that changed to an accident mode in response to the accident; and
coordinating, by the computing device, the virtual black box data and the stream of data for distribution to one or more accident-based services.

19. A system, comprising:
a server;
a vehicle; and
a road-side unit (RSU);
wherein the server is configured to determine identities of one or more occupants of a vehicle in conjunction with the vehicle, and to determine that the vehicle has been in an accident at a location;
wherein the RSU is in proximity to the vehicle at the time of the accident, and is configured to confirm, to the server, that the accident occurred at the location;
wherein the server is configured to receive, from one or both of the vehicle and RSU, virtual black box data having a finite time period of recorded data from one or more sensors that were in an operating mode during the finite time period prior to the accident;
wherein the server is further configured to receive, from one or both of the vehicle and RSU, a stream of data from at least one of the one or more sensors that changed to an accident mode in response to the accident; and
wherein the server is further configured to coordinate the virtual black box data and the stream of data for distribution to one or more accident-based services, and to provide access to medical records of the one or more occupants to one or more emergency service devices.

20. The system as in claim 19, wherein the vehicle is a car.
